(19) United States
(12) Patent Application Publication
(10) Pub. No.: US 2009/0162071 A1
(43) Pub. Date: Jun. 25, 2009

(54) Auto-Tracking System for Mobile Free-Space Optical (FSO) Communications

(76) Inventors: Hakki H. Refai, Bixby, OK (US); James J. Sluss, JR., Broken Arrow, OK (US)

Correspondence Address: DUNLAP CODDING, P.C., PO BOX 16370, OKLAHOMA CITY, OK, 73113, US

(21) Appl. No.: 11/960,207

(22) Filed: Dec. 19, 2007

(51) Int. Cl. H04B 10/00

(52) U.S. Cl. 398/131

(57) ABSTRACT

Free-space optics (FSO) is an unlicensed line-of-sight technology that uses modulated optical lasers to transmit information through the atmosphere. By using invisible beams of light, FSO can transmit and receive voice, video, and data information. To date, the primary concentration of FSO research and development has been toward the accurate alignment between two transceivers. The invention (FSO system) provides viable optical beam steering and capturing mechanism to allow fast tracking and accurate pointing between two transceivers of free-space optic (FSO) link that required continuous alignment. This extra ordinary auto-tracking system can reduce the time needed to lock a laser beam between an aircraft and a stationery base station to exchange information in addition to its high accuracy. This invention also provides wider receiving angle compared with the conventional FSO system.

### CROSS-REFERENCE TO RELATED APPLICATIONS

Not Applicable.

### STATEMENT REGARDING FEDERALLY SPONSORED RESEARCH AND DEVELOPMENT

Not Applicable.

### THE NAMES OF THE PARTIES TO A JOINT RESEARCH AGREEMENT

Not Applicable.

### REFERENCE TO A “SEQUENCE LISTING,” A TABLE, OR A COMPUTER PROGRAM LISTING APPENDIX SUBMITTED ON A COMPACT DISC AND AN INCORPORATION-BY-REFERENCE OF THE MATERIAL ON THE COMPACT DISC (SEE § 1.52(E) (5))

Not Applicable.

### BRIEF DESCRIPTION OF THE SEVERAL VIEWS OF THE DRAWINGS

FIG. 1 is a schematic, diagrammatic view of an exemplary free space optical system constructed in accordance with the present invention having at least two transceivers defining a communication channel.

FIG. 2 is a schematic, diagrammatic view of the exemplary free space optical system of FIG. 1 wherein one transceiver is located on an airplane and one transceiver is a ground station.

FIG. 3 is a schematic block diagram of the exemplary free space optical system of FIG. 1.

FIG. 4 is a perspective view of an exemplary transceiver having a transmitting part and a receiving part for use in the free space optical system of FIGS. 1 and 2.

FIG. 5 is a schematic diagram of a receiving part of the transceiver depicted in accordance with the present invention.

FIG. 6 is a schematic diagram illustrating a field of view of an exemplary transceiver constructed in accordance with the present invention.

FIG. 7 is a schematic diagram of an exemplary receiving part of the transceiver having a receiving lens and an array of electromagnetic wave sensors where the position of the focal point on the array of electromagnetic wave sensors changes depending upon the angle of incidence of a electromagnetic wave relative to the receiving lens.

FIG. 8 is a schematic diagram of another receiving part of a transceiver in accordance with the present invention.

FIG. 9 is a perspective view of an exemplary steering device for use with the transceiver depicted in FIG. 1 and constructed in accordance with the present invention.

### DESCRIPTION OF THE INVENTION

So that the present invention can be understood in detail, a more particular description of the invention may be had by reference to the embodiments thereof that are illustrated in the drawings. It is to be noted, however, that the drawings illustrate only typical embodiments of this invention and are therefore not to be considered limiting of its scope, for the invention may admit to other equally effective embodiments. Illustrative embodiments of the invention are described below. In the interest of clarity, not all features of an actual implementation are described in this specification. It will of course be appreciated that in the development of any such actual embodiment, numerous implementation-specific decisions must be made to achieve the developers' specific goals, such as compliance with system-related and business-related constraints, which will vary from one implementation to another. Moreover, it will be appreciated that such a development effort, even if complex and time-consuming, would be a routine undertaking for those of ordinary skill in the art having the benefit of this disclosure.

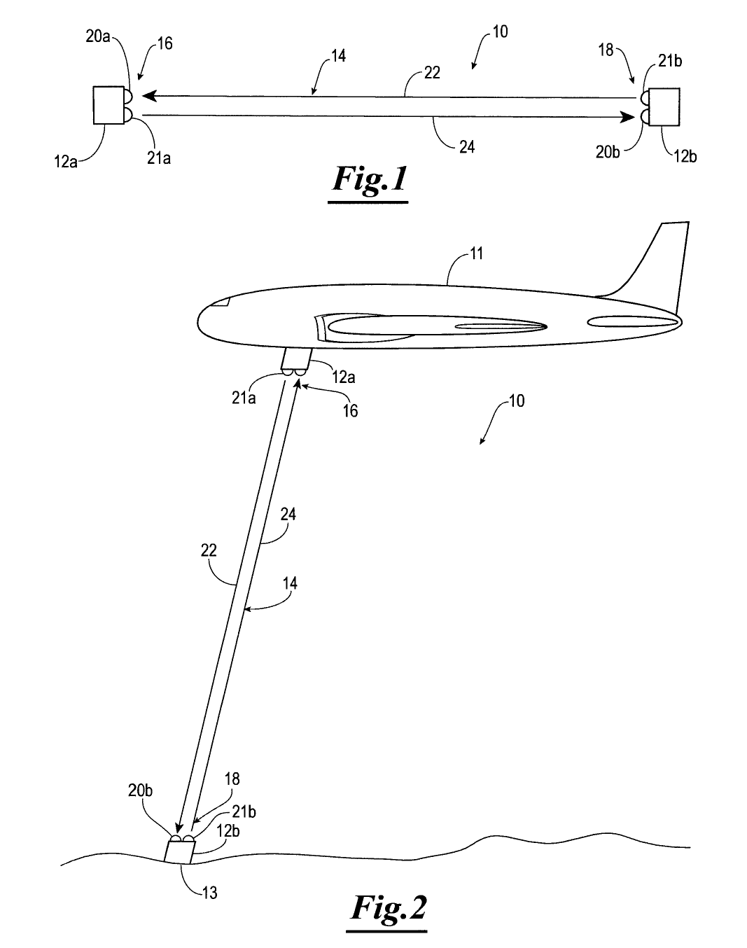

Referring now to the drawings and in particular to FIGS. 1 and 2, shown therein and designated by a reference numeral 10 is a free-space optics (FSO) system 10 constructed in accordance with the present invention. In general, free-space optics (FSO) is an unlicensed line-of-sight technology that uses a modulated electromagnetic wave, such as an optical beam produced by one or more optical lasers, to transmit information (i.e., carried data) through the atmosphere. The system 10 includes at least two spaced apart transceivers 12a and 12b defining a communication channel 14. The communication channel 14 is used to transmit and receive multi-media data, such as audio, voice, video, and data information between the transceivers 12a and 12b.

The free space optics system 10 can be used in a variety of applications, such as a last mile network, a temporary network, disaster recovery and emergency services, cellular connectivity, a virtual Point-to-Multi point network, mobile wireless connectivity, backbone internet connectivity, a satellite uplink connection or outside broadcast applications. The system 10 can also be used to form a part of an air-traffic control system. For example, in the example depicted in FIG. 2, the system 10 communicates bi-directionally between an airplane 11 and a ground station 13. In this example, the transceiver 12a is mounted to the airplane 11 and the transceiver 12b is mounted to the ground station 13. Alternatively, the system 10 may communicate bi-directionally between two airplanes having one of each transceiver 12a and 12b mounted on the airplanes. In another embodiment (not shown), the system 10 communicates bi-directionally between two moving vehicles having one of each transceiver 12a and 12b mounted on each moving vehicle.

Transmission of signals using prior art FSO systems generally provide high data rate exchange over a secure network, however, such systems are limited in reception as the goal is to provide accurate alignment between two receivers. See, “Free space optics for laser communications through the air,” D. Killinger, Optics and Photonics News, pp. 36-42, October 2002, the entire contents of which is incorporated by reference in its entirety. By the construction and design of the FSO system 10 as described herein, the FSO system 10 provides at least two advantages over prior art systems: 1) the current FSO system 10 provides a wide receiving angle even when there is no accurate alignment, and 2) the FSO system 10 provides an auto-tracking mechanism to lock both transceivers 12a and 12b together during mobile FSO communications. This auto-tracking mechanism can be even used with two fast mobile transceivers 12a and 12b. Additionally, the FSO system 10 provides low manufacturing cost, high tracking accuracy, and low weight for each transceiver 12a and 12b, which assist in the installation and use onboard a movable object such as an aircraft.

In general, the transceivers 12a and 12b are located at each side 16 or 18 of the communication channel 14. In the example shown in FIG. 1, the transceiver 12a is located at the side 16 of the communication channel 14, and the transceiver 12b is located at the side 18 of the communication channel 14.

Each transceiver 12a and 12b has a receiving part and a transmitting part. In particular, the transceiver 12a has a receiving part 20a and a transmitting part 21a. In the same regard, the transceiver 12b has a receiving part 20b and a transmitting part 21b.

The transmitting part 21a of the transceiver 12a directs a first electromagnetic wave 22 across the communication channel 14 to the receiving part 20b of the transceiver 12b. Likewise, the transmitting part 21b of the transceiver 12b directs a second electromagnetic wave 24 across the communication channel 14 to the receiving part 20a of the transceiver 12a. It should be noted that the designation of “first” and “second” does not necessarily imply a temporal relationship between the first electromagnetic wave 22 and the second electromagnetic wave 24 as described herein.

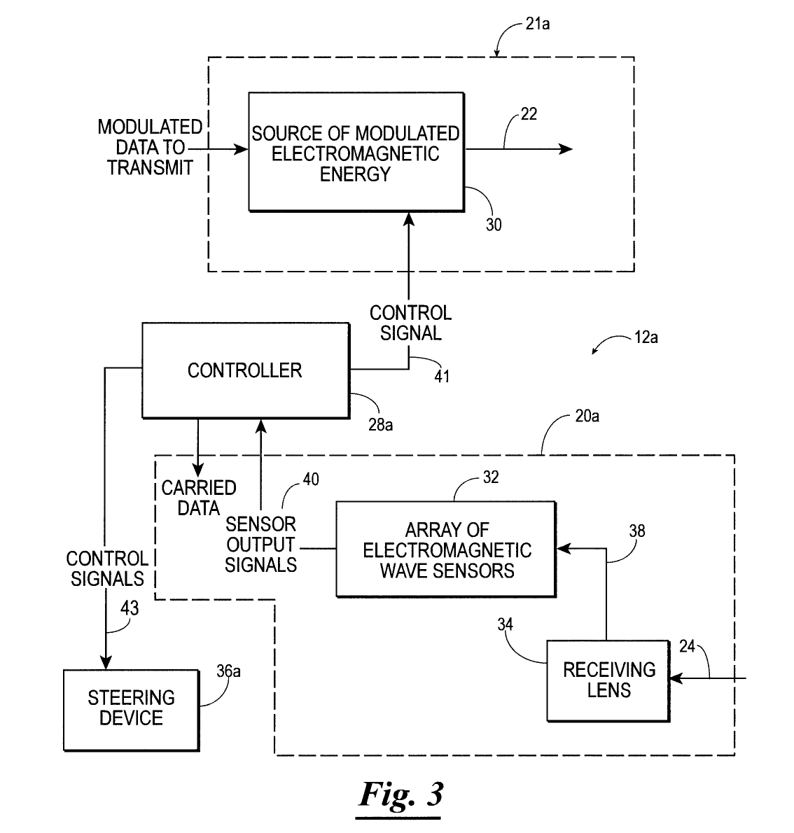

FIG. 3 is a block diagram of an exemplary transceiver 12a of the FSO system 10 constructed in accordance with the present invention. It should be understood that the transceivers 12a and 12b are similar in construction and function. Thus, only the construction of the transceiver 12a will be discussed in detail hereinafter.

In general, the transceiver 12a includes the receiving part 20a, a controller 28a, at least one steering device 36a, and the transmitting part 21a. In the preferred embodiment, the transceiver 12a also includes at least one steering device 36a. It should be noted, however, that the steering device 36a may be a separate component distinguishable from the transceiver 12a. The receiving part 20a of transceiver 12a includes an array of electromagnetic wave sensors 32 and a receiving lens 34. The receiving lens 34 receives the second electromagnetic wave 24 and provides a focused electromagnetic wave 38 to the array of electromagnetic wave sensors 32. The array of electromagnetic wave sensors 32 receives the focused electromagnetic wave 38 and generates a sensor output signal 40. The sensor output signal 40 is provided to the controller 28a of the transceiver 12a. The controller 28a analyzes the sensor output signal 40 and provides a first control signal 41 to the steering device 36. The controller 28a Analyzes the sensor output signal 40 and provides a first control signal 43 to the steering device 36. The controller 28a may also provide a second control signal 41 to the transmitting part 21a to control the optical output power of the electromagnetic wave being transmitted and/or to control an integral electronic steering device (not shown) included within the transmitting part 21a. The transmitting part 21a includes a source of modulated electromagnetic energy 30 that can be implemented in a variety of manners, such as an LED, laser and/or the like. It should be noted that the modulated electromagnetic energy 30 may be transmitted through the receiving lens 34 of the transceiver 12a. In this regard, the receiving lens 34 would have a dual function of receiving the second electromagnetic wave 24 and transmitting the first electromagnetic wave 22.

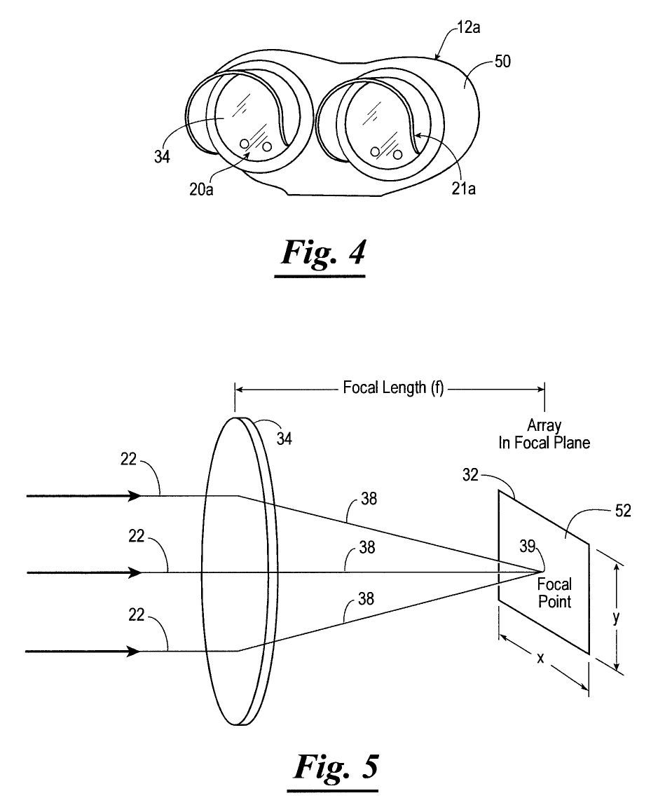

The receiving part 20a and the transmitting part 21a of the transceiver 12a are preferably mounted next to each other in a way that provides the functionality needed to steer the transmitting beam in addition to steering the receiving part 20a. As illustrated in FIG. 4, the mounting of the receiving part 20a and the transmitting part 21a may include a housing 50. Other elements of the transceiver 12a, such as the controller 28a and/or steering device 36, may also be positioned in or on the housing 50, or can be separate from or remote from such housing 50. It should be noted, the transmitting part 21a of the transceiver 12a and the receiving part 20a of the transceiver 12a may be separated.

FIG. 5 is a schematic diagram of one embodiment of the receiving part 20a of the transceiver 12a including the receiving lens 32 and the array of electromagnetic wave sensors 32. The receiving lens 34 may be any type of lens able to provide the focused electromagnetic wave 38. Examples of suitable receiving lens include bi convex, plano-convex, and the like.

The array of electromagnetic wave sensors 32 is mounted at the focal plane of the receiving lens 34 to receive the incident focused electromagnetic wave 38. Generally, the array of electromagnetic wave sensors 32 defines a receiving surface 52. Preferably, the array of electromagnetic wave sensors 32 is mounted at a distance substantially equal to the focal length (f) of the receiving lens 34 as illustrated in FIG. 5. As described herein, the focal length (f) is the distance from the surface of the receiving lens 34 to its focal point 39. Mounting of the electromagnetic wave sensors 32 at a distance substantially equal to the focal length (f) provides for the convergence of the focused electromagnetic waves 38 at the focal point 39. Alternatively, the array of electromagnetic wave sensors 32 is mounted at a pre-determined distance (d) and the position of the focused electromagnetic waves 38 can be algorithmically determined.

The array of electromagnetic wave sensors 32 receives the focused electromagnetic wave 38 and converts the focused electromagnetic wave 38 into a format capable of being measured, such as, for example, an electric format. Examples of suitable electromagnetic wave sensors for use in the array 32 include photosensors, such as photodiodes, phototransistors, charge-coupled devices, a position sensing photodiode, and/or the like. In the preferred embodiment, at least a portion of the array of electromagnetic wave sensors 32 is composed of PSDs. As described herein, a PSD is a photodetector that provides measurements indicative of a variety of factors, such as position, power, spot size and spot shape of an incident optical beam or spot image.

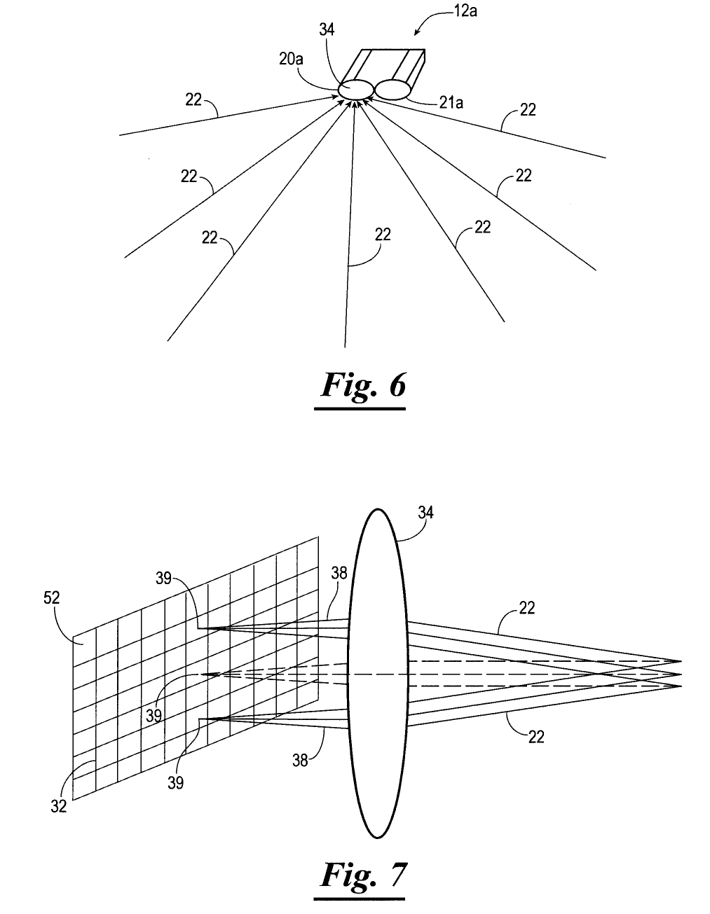

The electromagnetic wave sensors 32 detect a variety of factors indicative of the focused electromagnetic wave 38, such as optical power and position. The electromagnetic wave sensors 32 can measure the optical power at any location within its receiving surface 52. By using the array of electromagnetic wave sensors 32, the receiving surface 52 has an area greater than a portion of the receiving surface 52 formed by any single photodetector in the array. Reading the optical power at any location at the focal plane (or away from the focal plane) allows the receiving lens 34 the ability to receive the electromagnetic waves 22 from any direction. This ability increases the receiving range of the transceiver 12a as illustrated in FIG. 6.

As illustrated in the schematic diagram of FIG. 7, the focal point 39 on the array of electromagnetic wave sensors 32 changes depending upon the angle of incidence of the electromagnetic wave 22 relative to the receiving lens 34. For example, when electromagnetic wave 22 is perpendicularly incident to the receiving lens 34, the focal point 39 will be desirably located at the center of the receiving surface 52 of the array of electromagnetic wave sensors 32. Alternatively, when the electromagnetic wave 22 is incident on the receiving lens 34 with an angle from the off-axis of the receiving lens 34, the focused electromagnetic wave 38 will be positioned at a different location from the center according to the value of the receiving angle. As such, the receiving lens 34 will typically concentrate the optical power at the receiving surface 52 of the array of electromagnetic wave sensors 32 at a location specified by the value of the incident angle from the off-axis of the receiving lens 34. The position readings of this focal point 39 can be used by the controller 28a to generate control signal 43 to the steering device 26 in order to realign the receiving lens 34 such that the focal point 39 is located at the center of the receiving surface 52.

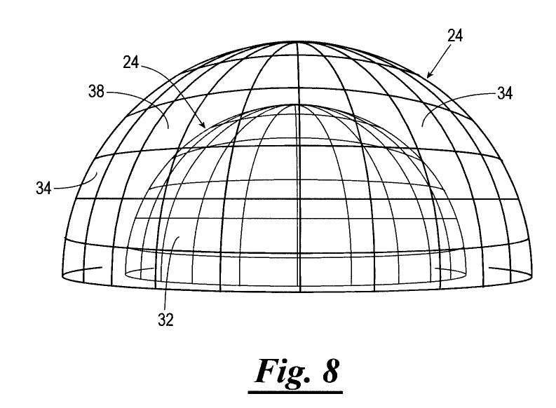

FIG. 8 illustrates another embodiment of the receiving part 20a having multiple receiving lenses 34 in a spherical arrangement. The array of electromagnetic wave sensors 32 are mounted at the focal plane of each corresponding receiving lens 34 to receive the incident focused electromagnetic waves 38. The array of electromagnetic wave sensors 32 also defines a spherical receiving surface 52a.

The sensor output signals 40 produced by the electromagnetic wave sensors 32 are then passed to one or more controllers 28a (or associated device(s) or system(s)). The sensor output signals 40 can be passed to the controller 28a from the electromagnetic wave sensors 32 utilizing any suitable communication link, such as a wired communication link, a wireless communication link, or combinations thereof.

The controller 28a analyzes the signals to demodulate and extract the carried data from the received electromagnetic wave (i.e., the electromagnetic wave 24). The controller 28a reads the measured optical power and demodulates the signal according to the modulation scheme used in the FSO system 10. For example, the modulation can be on-off keying modulation or any other type of modulation.

The controller 28a of the free space optical system 10 can also be used to generate one or more control signal 43 according to its position readings to control the steering device 36 of the receiving part 20a. The controller 28a communicates the control signal 43 to the steering device 36 using any suitable communication system, such as a wired or wireless communication system. In generating the control signals 41 and/or 43, the controller 28a analyzes the measurement of position of the focal point 39. For example, if position readings obtained by the controller 28a are (x, y)=(1, 0), the generated control signal 41 would direct the steering device 36 to move in the x-direction 1 degree and remain fixed in the y-direction.

The steering device 36 directs the electromagnetic wave 24 to the electromagnetic wave sensors 32 through the receiving lens 34. The steering device 36 can move the receiving lens 34 and/or the electromagnetic wave sensors 32, or can steer the electromagnetic wave 22 or combinations thereof. Additionally, more than one steering device 36 may be used in the receiving part 20a to direct the electromagnetic wave 24 to the array of electromagnetic sensors 32. Further, it should be understood that the steering devices 36 can have different effects on the incident beam, or the receiving lens 34. For example, one of the steering devices 36 can be adapted and/or utilized for a coarse adjustment, and another one of the steering devices 36 can be adapted and/or utilized for a fine adjustment.

The steering device 36 can be implemented in a variety of manners, such as a motor (stepper, AC or DC) a solenoid, a steering mirror or the like. For example, the receiving part 20a can be provided with two stepper or DC motors installed beneath transceiver 12a (or at any suitable location) to control the direction of where the transceiver 12a is pointing. The steering device 36 should be installed in a way that provide capabilities of receiving the control signal 43 and directing the transceiver 12a toward any location in the three dimensional space. For example, the use of a gimbal within the steering device 36 can allow for the free rotation of the transceiver 12a to tilt freely in any direction.

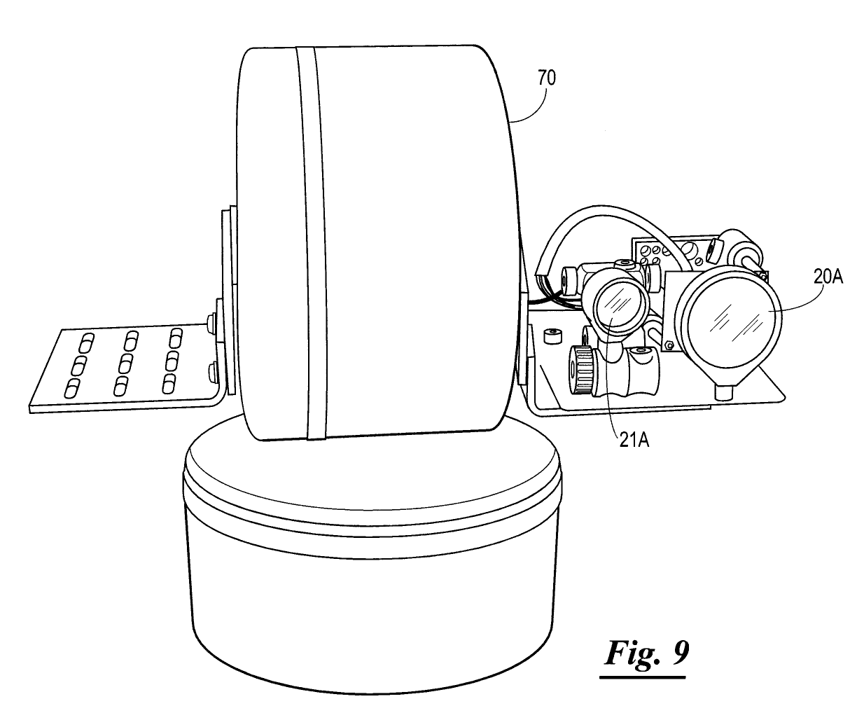

FIG. 9 illustrates one embodiment of the transceiver 12a in which the steering device 36 includes the use of a gimbal 70 allowing for movement of the receiving part 20a and the transmitting part 21a in the x and y directions. The gimbal 70 can be implemented in a variety of manners. For example, the gimbal 70 can be a pan and tilt gimbal, such as a Model 20 Servo, manufactured by Sagebrush Technology, Inc. of Albuquerque, N. Mex. A copy of a specification document for the Model 20 Servo manufactured by Sagebrush Technology is included in an information disclosure statement filed contemporaneously herewith and is incorporated by reference in its entirety.

The controller 28a of the free space optical system 10 can also be used to generate control signals according to its position readings to control a second steering device 36b within the transmitting part 21a. The controller 28a communicates with the transmitting part 21a using any suitable communication system, such as a wired or wireless communication system. For example, in one preferred embodiment, the controller 28a communicates the control signals to the transmitting part 28a utilizing a transmitter of the receiver part 20a utilizing an out of band modulated laser beam.

Alternatively, the controller 28a of the free space optical system 10 can be used to generate controls signals 41 and 43 to both the receiving and transmitting parts 20a and 21a separately. Repositioning the receiving and transmitting parts 20a and 21a separately can be effective when using one of several available steering technologies, for example, Micro-electro-mechanical (MEMS)-microlens arrays, galvanometric scanners, optical phased arrays, acousto-optic scanners, and optical phased prism arrays and the like.

It should be understood that the controller 28a can be implemented as any device suitable for performing the functions described above. For example, the controller 28a can be implemented as a computer system running software adapted to perform the functions described above, and the software and carried data can be stored on one or more computer readable mediums. Examples of a computer readable medium include an optical storage device, a magnetic storage device, an electronic storage device, or the like. The term “Computer System” as used herein means a system or systems that are able to embody and/or execute the logic of the processes described herein. The logic embodied in the form of software instructions or firmware may be executed on any appropriate hardware which may be a dedicated system or systems, or a general purpose computer system, or distributed processing computer system, all of which are well understood in the art, and a detailed description of how to make or use such computers is not deemed necessary herein. When the computer system is used to execute the logic of the processes described herein, such computer(s) and/or execution can be conducted at a same geographic location or multiple different geographic locations. Furthermore, the execution of the logic can be conducted continuously or at multiple discrete times.

Contemplated herein is a method of using an FSO system 10. This method generally includes the step of initially determining the location of each transceiver 12a and 12b. The locations of each transceiver 12a and 12b may be determined using any suitable method such as, for example, through a global positioning system. Upon determining the location of each transceiver 12a and 12b, the transceivers 12a and 12b are directed towards each other to form the communication channel 14. Once the communication channel 14 is formed, the FSO system 10 adjusts the positions of the transmitting and receiving parts of both transceivers 12a and 12b without having to provide updated location information of each transceiver 12a and/or 12b. Adjustment of the transceivers 12a and 12b maintains the communication channel 14 between the transceivers 12a and 12b such that electromagnetic waves 22 and 24 are able to be transmitted and received to the transceivers 12a and 12b.

This description is intended for purposes of illustration only and should not be construed in a limiting sense. The scope of this invention should be determined only by the language of the claims that follow. The term “comprising” within the claims is intended to mean “including at least” such that the recited listing of elements in a claim are an open group. “A,” “an” and other singular terms are intended to include the plural forms thereof unless specifically excluded.

1. A free space optics system, comprising:
at least two spaced apart transceivers defining a communications channel having at least two sides with each transceiver located at each side of the communications channel and directing an electromagnetic wave across the communications channel to the other transceiver, each transceiver comprising:
a transmitting part directing the modulated steerable electromagnetic wave to the communications channel;
a receiving part comprising:
a receiving lens receiving the modulated steerable electromagnetic wave from the transmitting part of the other transceiver, and providing the focused electromagnetic wave;
an array of electromagnetic wave sensors receiving the focused electromagnetic wave and generating a sensor output signal indicative of the power of the focused modulated steerable electromagnetic wave as well as the position of the focused modulated steerable electromagnetic wave on the array of electromagnetic wave sensors; and,
a steering device that aligns the aforementioned transceivers such that the modulated steerable electromagnetic wave is directed to the array of electromagnetic wave sensors through the receiving lens; and
a controller receiving the sensor output signal and generating control signals to control the steering device of the receiving part.

2. The free space optics system of claim 1, wherein the controller demodulates and extracts carried data from the sensor output signal.

3. The free space optics system of claim 3, wherein the steering device includes at least two motors for changing the position of the receiving part.

4. The free space optics system of claim 1, wherein the controller is adapted to generate the control signals to control the steering device of the receiving part based upon the data in the sensor output signal indicative of the position of the focused beam of electromagnetic waves within the array of electromagnetic wave sensors.

5. A first transceiver for communicating with a second transceiver via a communications channel, the first transceiver, comprising:
a transmitting part adapted to direct a modulated steerable electromagnetic wave to the communications channel;
a receiving part comprising:
a receiving lens adapted to receive a modulated steerable electromagnetic wave from the communications channel, and providing a focused electromagnetic wave;
an array of electromagnetic wave sensors receiving the focused electromagnetic wave and generating a sensor output signal indicative of the power of the focused modulated steerable electromagnetic wave as well as the position of the focused modulated steerable electromagnetic wave on the array of electromagnetic wave sensors; and,
a steering device that aligns the receiving lens with the modulated steerable electromagnetic wave such that the modulated steerable electromagnetic wave is directed to the array of electromagnetic wave sensors through the receiving lens; and
a controller receiving the sensor output signal and generating control signals to control the steering device of the receiving part.

6. The free space optics system of claim 5, wherein the controller demodulates and extracts carried data from the sensor output signal.

7. The free space optics system of claim 5, wherein the controller is adapted to generate the control signals to control the steering device of the receiving part based upon the data in the sensor output signal indicative of the position of the focused beam of electromagnetic waves within the array of electromagnetic wave sensors.

8. A method for using a free space optics system to communicate over a communications channel utilizing at least two transceivers with each of the communications stations having a transmitting part and a receiving part, the method comprising the steps of:
determining the location of each transceiver;
directing the transceivers towards each other to form the communication channel;
adjusting the positions of the transmitting and receiving parts of both transceivers without having to provide updated location information of each transceiver.

9. The method of claim 8, wherein the step of determining the location of each transceiver is defined further as utilizing a global positioning system to determine the location of each communications channel.
